(19) United States
(12) Patent Application Publication
(10) Pub. No.: US 2022/0274856 A1
(43) Pub. Date: Sep. 1, 2022

(54) PHYTO-MEDIATED WASTEWATER TREATMENT BIOREACTOR (PWBR)

(71) Applicant: ARIZONA BOARD OF REGENTS ON BEHALF OF THE UNIVERSITY OF ARIZONA, Tucson, AZ (US)

(72) Inventors: Matthew S. Recsetar, Tucson, AZ (US); Joel L. Cuello, Tucson, AZ (US)

(21) Appl. No.: 17/631,653

(22) PCT Filed: Jul. 31, 2020
(86) PCT No.: PCT/US20/44523

§ 371 Date: Jan. 31, 2022

Related U.S. Application Data
(60) Provisional application No. 62/880,798, filed on Jul. 31, 2019.

(51) Int. Cl. C02F 3/32; C02F 3/00; C02F 3/06; C02F 1/00; C02F 1/28; C02F 1/32; C02F 1/78

(52) U.S. Cl. CPC C02F 3/327; C02F 3/006; C02F 3/06; C02F 1/001; C02F 1/283; C02F 1/32; C02F 1/78; C02F 2203/006; C02F 2301/046

(57) ABSTRACT

A phyto-mediated wastewater treatment bioreactor (PWBR) for treating wastewater effluent and agricultural effluent is disclosed herein. The PWBR is used to clean and remove emerging contaminants from water. These emerging compounds include, but are not limited to, pharmaceutical compounds, steroids and hormones, and industrial and household chemicals. Plants and/or the microorganisms adhering to the plant roots and their growing medium have the ability to take up many of these contaminants and the PWBR maximizes their treatment capability in a given space and time.

### CROSS-REFERENCES TO RELATED APPLICATIONS

This application claims benefit of U.S. Provisional Application No. 62/880,798, filed Jul. 31, 2019, the specification(s) of which is/are incorporated herein in their entirety by reference.

### BACKGROUND OF THE INVENTION

### Field of the Invention

The present invention relates to wastewater treatment, in particular, to removing Contaminants of Emerging Concern (CECs) from wastewater.

### Background Art

Contaminants of emerging concern (CECs) refer to a wide range of chemicals that can accumulate in the environment, for example, water run-off from agriculture or municipal wastewater. CECs include pharmaceuticals and personal care products, organic wastewater compounds, antimicrobials, antibiotics, animal and human hormones, as well as domestic and industrial detergents. Many of these compounds are not currently regulated by a regulatory authority and may be potentially harmful to humans and the environment. Hence, the effects of CECs on the environment and aquatic ecosystems pose a critical environmental management issue.

Traditional wastewater treatment processes use physical, chemical and biological methods to make the water safe enough to release back into the environment. To remove many of these CECs would typically require much more expensive treatment methods such as reverse-osmosis, carbon filtration, ozone or ultraviolet light (UV). However, constructed wetlands (CWs) which have been used in wastewater treatment for decades have been shown to greatly reduce and even eliminate many of these CECs. Various types of CWs have been used for wastewater treatment including those with surface flow and subsurface flow. However, surface flow CWs were shown to have poor removal (<25%) for many contaminants commonly found in wastewater effluent.

While it may not be possible to build a subsurface flow constructed wetland to treat the effluent at every wastewater treatment plant due to space, climate and other restrictions, it may be possible to recirculate batches of wastewater through a smaller, and optionally mobile, hydroponic media bed.

### BRIEF SUMMARY OF THE INVENTION

It is an objective of the present invention to provide systems and methods for wastewater treatment, as specified in the independent claims. Embodiments of the invention are given in the dependent claims. Embodiments of the present invention can be freely combined with each other if they are not mutually exclusive.

In some aspects, the present invention features a phyto (plant)-mediated wastewater treatment bioreactor (PWBR) for treating various types of wastewater to remove contaminants. Of special interest in the use of the PWBR is the removal of CECs from wastewater, which include, but are not limited to, pesticides, pharmaceuticals, personal care products, polycyclic aromatic hydrocarbons, perfluorinated compounds and engineered nanomaterials. Without wishing to be bound to a particular theory or mechanism, plants can assimilate and bioaccumulate CECs as well as break them down through secretion of root exudates. Further, microorganisms (e.g., bacteria, fungi, etc.) adhering to the surfaces of the plant roots and growing medium may also help in the degradation of CECs.

In some aspects, the PWBR may comprise the following components: (1) a container; (2) flow guides or baffles; (3) growing medium; (4) influent port; (5) effluent port; (6) plants; and (7) microorganisms adhering to surfaces of the growing medium and plant roots. Wastewater enters from the influent port, flows and/or recirculates through the PWBR, and exits through the effluent port. Without wishing to limit the present invention, it is believed that the PWBR has the following advantages: 1) Modularity; 2) Portability; 3) Scalability; 4) Amenability to optimization for removal of a specific CEC based on design variables; 5) Moderate cost; and 6) Compatibility to allow for inclusion or combination with other treatment methods, e.g., ozone, ultraviolet (UV) radiation, activated carbon, etc. None of the presently known prior references or work has the unique inventive technical feature of the present invention.

While the invention can be used for treatment of CECs, the invention is not limited to just CECs. In some embodiments, the PWBR may also be used for the treatment of other contaminants, including but not limited to heavy metals, radioisotopes, arsenic, lead, mercury, PCBs, residual forms of nitrogen, phosphorus, etc. Non-limiting examples of wastewater that may be treated using the PWBR include secondary and tertiary treated municipal wastewater, contaminated well water, farm effluent, aquaculture effluent, and the like. The present invention may also be used to treat other sources of contaminated water, for example, contaminated bodies of water such as rivers, lagoons, lakes, and ponds (e.g. ash and waste ponds).

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic of a phyto-mediated wastewater treatment bioreactor (PWBR) according to an embodiment of the present invention.

FIG. 2 is side view schematic of the PWBR with growing medium.

FIG. 3 shows a prototype example of the PWBR.

FIG. 4A is a side view schematic of the PWBR with growing medium and plants.

FIG. 4B is a top view schematic of the PWBR with growing medium and plants.

FIG. 5A is a side view schematic of the PWBR with plants in an aqueous medium without a growing medium.

FIG. 5B is a top view schematic of the PWBR with plants in an aqueous medium without a growing medium.

FIG. 6A shows a top view schematic of the PWBR with a radial straight baffle configuration.

FIG. 6B shows a top view schematic of an alternative embodiment of the PWBR.

FIG. 7 shows a prototype example of the PWBR in accordance with the embodiment of FIG. 6B.

FIG. 8A shows a top view schematic of an alternative embodiment of the PWBR.

FIG. 8B is a top view schematic of another embodiment of the PWBR.

FIG. 9A shows a top view schematic of an alternative embodiment of the PWBR.

FIG. 9B is a top view schematic of another embodiment of the PWBR.

FIG. 10A is a top view schematic of an alternative embodiment of the PWBR.

FIG. 10B is a top view schematic of another embodiment of the PWBR.

FIG. 11A is a Residence Time Distribution curve that measures the distribution of times it takes for suspended particles to move through a continuous-flowing PWBR that has no baffles.

FIG. 11B is a Residence Time Distribution curve that measures the distribution of times it takes for suspended particles to move through a continuous-flowing PWBR comprising light expanded clay aggregate as the growing medium.

FIG. 12 is a Mixing Time graph that assesses how long it takes for an injected tracer to become uniformly distributed throughout the PWBR.

### DETAILED DESCRIPTION OF THE INVENTION

Following is a list of elements corresponding to a particular element referred to herein:

100 phyto-mediated wastewater treatment bioreactor

110 container

112 upstream end

114 downstream end

120 influent port

125 effluent port

130 flow guides

135 container sections

140 growing medium

150 plant units

As used herein, contaminants of emerging concern (CEC) is a collective phrase that covers a wide range of environmental contaminants such as pharmaceuticals and personal care products, endocrine disrupting compounds, organic wastewater compounds, antimicrobials, antibiotics, animal and human hormones, as well as domestic and industrial detergents. Pharmaceuticals and personal care products include personal health or cosmetic products such as over-the-counter medication (e.g., aspirin and acetaminophen), prescription medication, soaps, detergents, shampoo, lotions, sunscreen products, fragrances, insect repellants, and antibacterial compounds like triclosan. Natural and synthetic hormones include but are not limited steroids, corticosteroids, estrogens, progesterone, and testosterone. Other examples of CECs are Bisphenol A (BPA), brominated compounds for fire retardants, and pesticides. Pesticide types are specific to their intended target, for example herbicides, insecticides, rodenticide, and fungicides. Non-limiting examples of pesticides include organochlorines, organophosphates, triazines, and pyrethroids.

Referring now to the figures, in some embodiments, the present invention features a phyto-mediated wastewater treatment bioreactor (PWBR). The PWBR comprises a flow path, a growing medium disposed in the flow path, and a plurality of plant units planted in the growing medium. Wastewater containing a first concentration of dissolved contaminants is introduced into the flow path via an influent port. Without wishing to be bound to a particular theory or mechanism, as the wastewater flows through the flow path, the plant units and/or microorganisms adhering to surfaces of the plant roots and growing medium assimilate, bioaccumulate and/or break down the contaminants such that the wastewater exits through, an effluent port with a reduced concentration of contaminants.

In other embodiments, the present invention features a phyto-mediated wastewater treatment bioreactor (PWBR). The PWBR may comprise a container having an upstream end and a downstream end, an influent port fluidly coupled to the container at the upstream end, an effluent port fluidly coupled to the container at the downstream end, a plurality of flow guides disposed in the container, the flow guides dividing the container into a plurality of fluidly connected container sections, a growing medium disposed in the container sections, and a plurality of plant units planted in the growing medium. Wastewater containing a first concentration of dissolved contaminants can be introduced into the container via the influent port and is flowed through the container sections. Without wishing to be bound to a particular theory or mechanism, the plant units and/or microorganisms adhering to surfaces of the plant roots and growing medium assimilate, bioaccumulate and/or break down the contaminants such that the wastewater exits through the effluent port with a reduced concentration of contaminants.

According to other embodiments, the present invention features a method of removing contaminants of emerging concern (CECs) from wastewater. The method may comprise providing the PWBR as disclosed herein, introducing the wastewater into the container via the influent port, and flowing the wastewater through the PWBR. The plant units and/or microorganisms adhering to surfaces of the plant roots and growing medium assimilate, bioaccumulate and/or break down the contaminants such that the wastewater exits through the effluent port with a reduced concentration of CECs, thereby producing treated wastewater. In some embodiments, the method may further comprise recirculating the wastewater through the PWBR. In other embodiments, the method may further comprise collecting and recycling the treated wastewater. For example, the treated wastewater may be used as reclaimed or non-potable water. In still other embodiments, the method may further comprise treating the wastewater with ozonation, ultraviolet (UV) radiation, activated carbon, filtration, distillation or a combination thereof. The co-treatments may be performed prior to or after treatment by the PWBR.

In accordance with the embodiments herein, the configuration of the PWBR is described as follows. In some embodiments, the container may be cubic, rectangular cubic, cylindrical, or asymmetrical in shape. The container may be dimensioned to achieve a desired volume and/or surface area for growing the plant units and containing a specified fluid volume.

In one embodiment, for a rectangular shaped container, the influent port and effluent port are disposed on opposing sides of the container. In another embodiment, considering a circular shaped container, the influent port and effluent port may be diametrical opposite of each other. In another embodiment, the influent port may be higher than or at the same height as the effluent port.

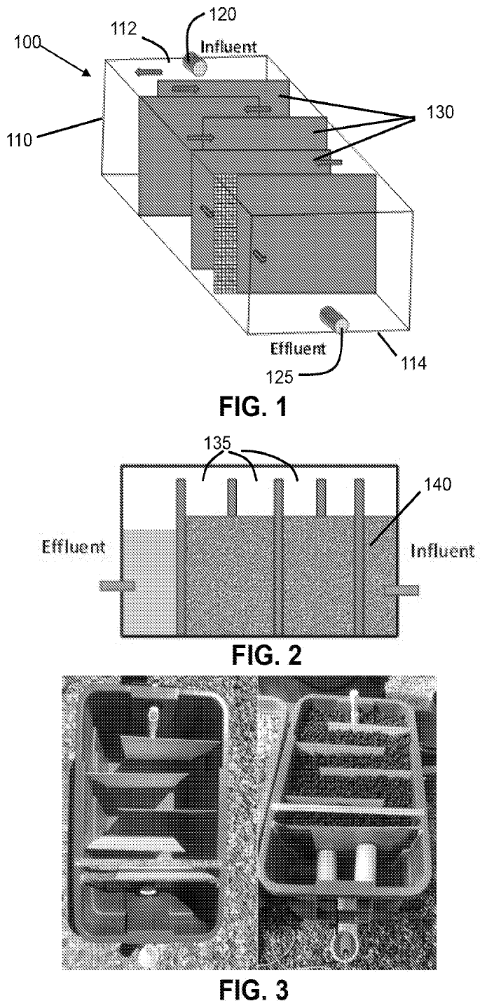

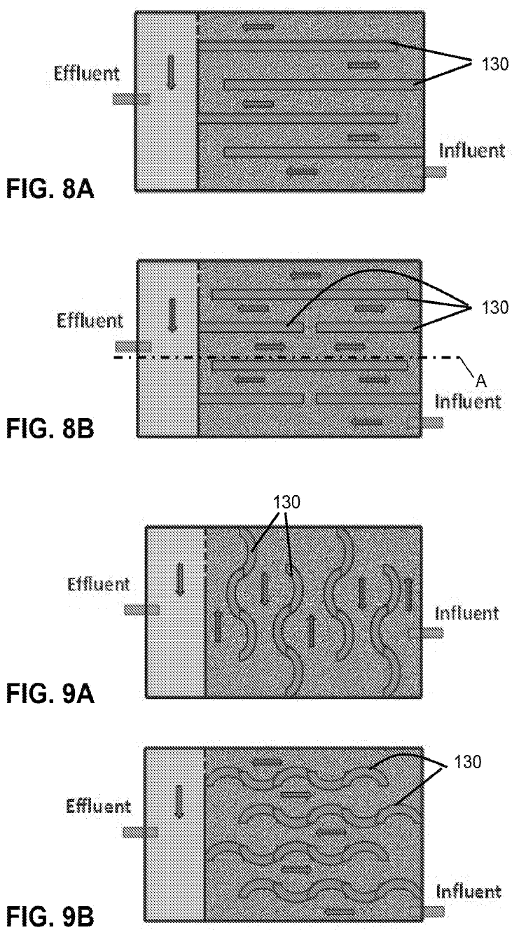

In some embodiments, the plurality of flow guides may comprise about 2 to 30 flow guides or more than 30 flow guides. The flow guides may be arranged to be parallel to each other. For example, the flow guides may be oriented radially relative to an axis (A) extending from the upstream end to the downstream end, as shown in FIGS. 1-7. In one embodiment, the axis (A) may intersect the influent port and effluent port. Alternatively, the flow guides are oriented axially relative to an axis (A) extending from the upstream end to downstream end, as shown in FIGS. 8A-8B.

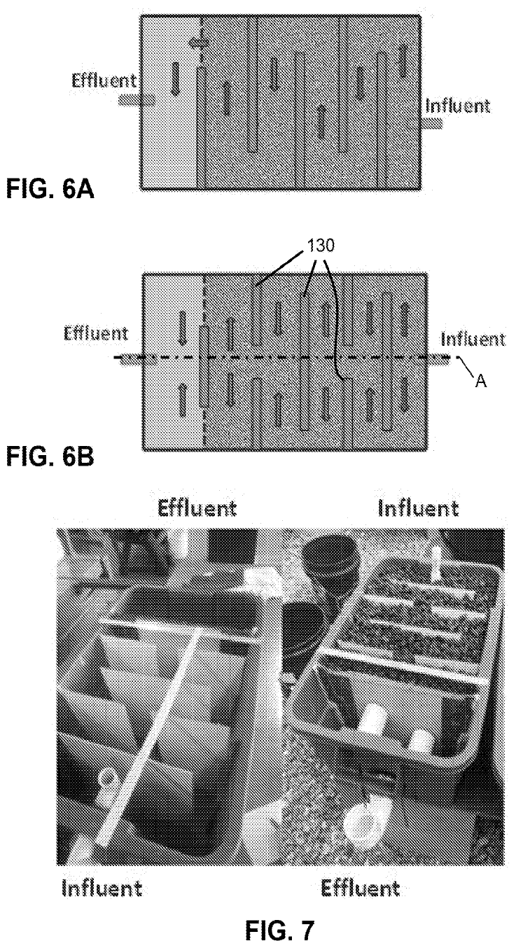

In other embodiments, the flow guides are configured to guide both direction and path of flow. For example, the flow guides are baffles. In one embodiment shown in FIGS. 6A and 8A, the flow guides are arranged such that the container sections form a serpentine path of flow. In another embodiment shown in FIGS. 6B and 8B, the flow guides are arranged such that the path of flow splits and converges. Alternatively, the flow guides are oriented to be parallel and perpendicular relative to each other, in other words, some of the flow guides are oriented and the other flow guides are oriented axially, thus creating a maze-like flow path (not shown).

In some embodiments, the flow guides may comprise a polymer or metal material. In other embodiments, the flow guides are solid or perforated. In some embodiments, the flow guides may comprise wire netting. In some embodiments, the flow guides are straight panels. In other embodiments, the flow guides are zigzag, trapezoidal, straight or wavy corrugated panels or ribbed panels.

In one embodiment, the growing medium may comprise solid particulates. Non-limiting examples of the particulates include fractured rocks, lava rocks, soil, sand, expanded clay, peat moss, perlite, vermiculite, or a combination thereof. In another embodiment, the growing medium may comprise the wastewater itself.

In some embodiments, the plant units can vary in species, variety, age, size, morphology, and planting density. For example, the species or combinations of species of plant units may be selected based on the specific contaminant to be removed from the wastewater. Non-limiting examples of the plant units include grass sunflowers, beans or vining plants, lettuce, cabbages, beets, grains, cress, weeds, etc.

In some embodiments, microorganisms adhere to surfaces of the plant roots and growing medium. Examples of the microorganisms include, but are not limited to, Pseudomonas fluorescens, Pseudomonas putida, Burkholderia cepacia, Azospirillum lipoferum, or Enterobacter cloacae.

Preferably, the PWBR can significantly reduce the contaminant concentration of the wastewater. In one embodiment, the PWBR may reduce the contaminant concentration (effluent) by at least 50% from the initial (influent) concentration. In another embodiment, the PWBR may reduce the contaminant concentration by at least 75%. In yet another embodiment, the PWBR may reduce the contaminant concentration by at least 90%.

In some embodiments, the PWBR is designed to move the wastewater in a single-pass through the PWBR. In other embodiments, the PWBR re-circulates the wastewater through the PWBR. For example, the PWBR may further include a pump and/or paddle for moving the wastewater through the PWBR. Preferably, one or more of volumetric flow rate, flow velocity, depth, and temperature can be controlled and/or varied to maintain plant stability and achieve maximum reduction in contaminant concentration.

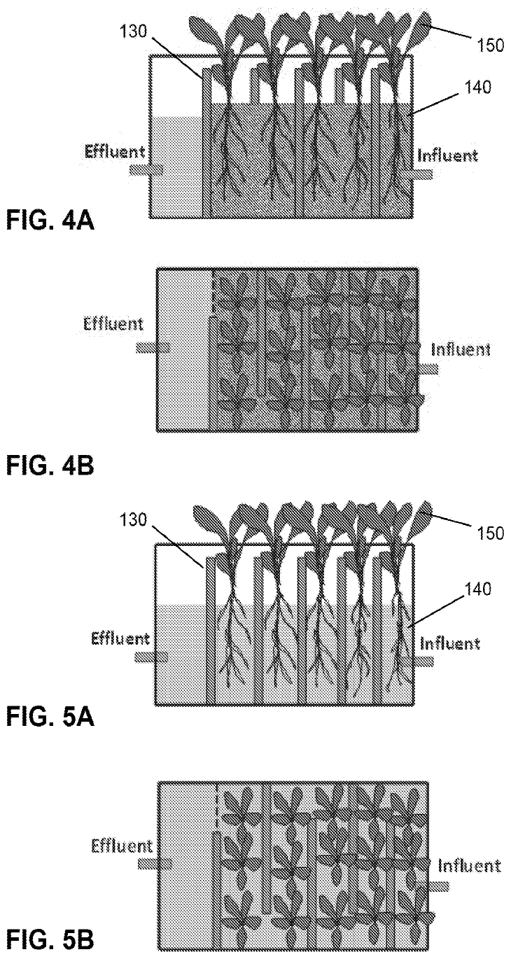

In FIG. 1, the arrows in the PWBR show the direction of liquid flow from the influent to the effluent. FIG. 2 shows the PWBR with particulate as a growing medium. FIG. 3 shows a prototype of the PWBR with (right) and without (left) the growing medium. FIGS. 4A-4B shows the PWBR with plants growing in the growing medium.

In an alternative embodiment of the PWBR shown in FIGS. 5A-5B, the plants are growing in a growing medium comprising wastewater instead of particulates. This is similar to a hydroponic system in Which plants are grown in a water based, nutrient rich solution as opposed to soil.

FIGS. 6A-10B show various embodiments of PWBR based on the geometric configuration and orientation of their flow guides or baffles. Other embodiments of PWBR can be designed in part by using other geometric configurations and orientation of their baffles.

FIG. 6A shows an embodiment of the PWBR with a radial straight baffle configuration. Radial is relative to the influent-effluent axis such that the baffles are perpendicular to the axis. FIG. 6B shows an embodiment of the PWBR where the straight baffles may be split. FIG. 7 is a sample prototype of the PWBR with a radial split straight baffle configuration.

FIG. 8A shows an embodiment of the PWBR with an axial straight baffle configuration. Axial is relative to the influent-effluent axis such that the baffles, are parallel to the axis. FIG. 8B shows an embodiment of the PWBR where the straight axial baffles may be split.

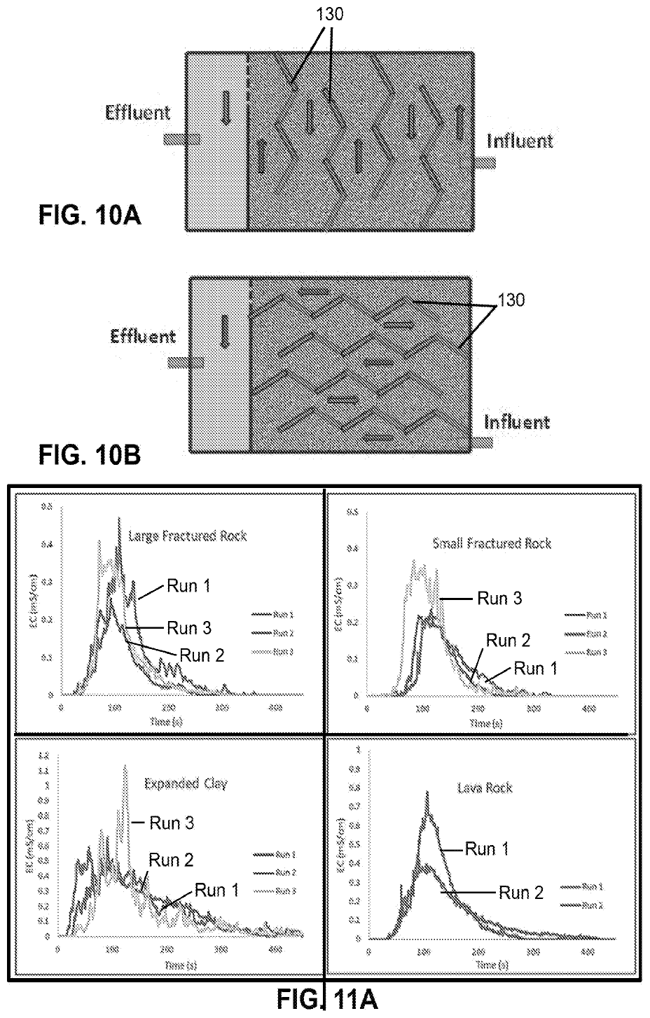

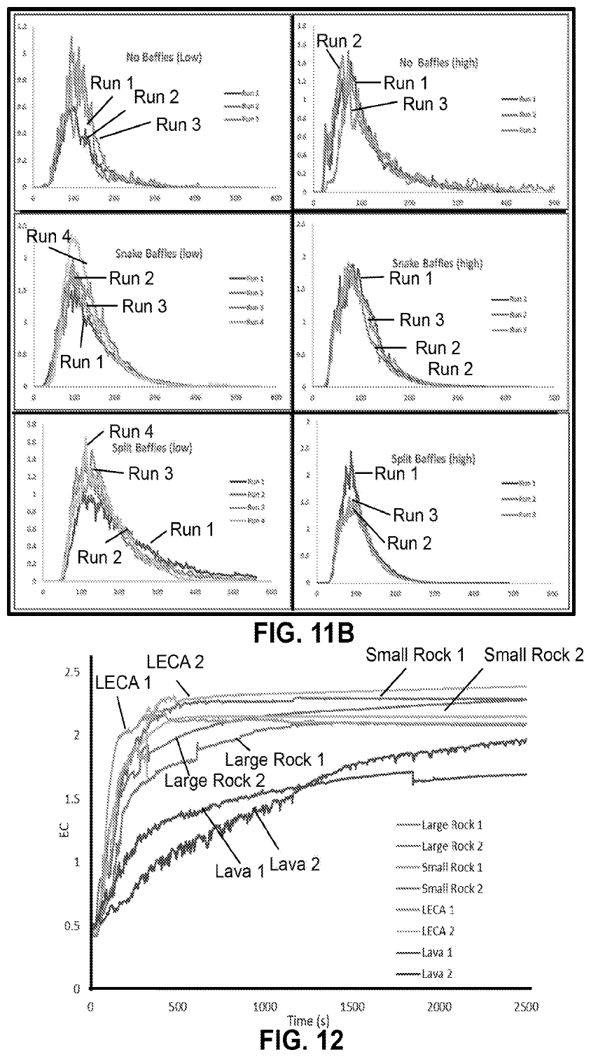

In some embodiments, the baffles may be non-linear, e.g. not straight. FIG. 9A is an alternative embodiment of the PWBR with curved baffles in a radial configuration. FIG. 9B is an alternative embodiment of the PWBR with curved baffles in the axial configuration. FIG. 10A is an alternative embodiment of the PWBR with zigzag baffles in a radial configuration. FIG. 10B is an alternative embodiment of the PWBR with zigzag baffles in the axial configuration.

In some embodiments, the container is a modular and portable container used to contain the baffles, growing medium, and plants. Wastewater can flow through the container for treatment. The container may vary in shape, for example, the container may be cubic, rectangular cubic, cylindrical, asymmetric, etc. The container may vary in dimensions to allow for sufficient volume of wastewater to be contained for treatment.

In some embodiments, the flow guides or baffles serve to guide both the direction and path of flow. Preferable, the flow guides may assume various geometric configurations and may vary in number, dimensions, material (polymer, metal, etc.), porosity (solid or perforated), surface finish, etc.

In other embodiments, the growing medium may comprise solid particulates. The particulates can vary in material (e.g., rock, lava rock, expanded clay, etc.), particle shape, particle size, porosity, adsorptivity, etc. Alternatively, the PWBR may be operated using the wastewater as the growing medium and without solid particulates to support the root system of the plants.

In some embodiments, the PWBR may be capable of employing a single-pass mode or multiple-pass/recirculation mode for the wastewater through the PWBR. The PWBR may be equipped with a pump that can recirculate the wastewater. Preferably, the volumetric flow rate/flow velocity, depth, temperature, etc., of the wastewater may be controlled and/or varied to achieve maximum reduction in contaminant concentration and plant stability.

In other embodiments, the plants are used for stabilization and/or uptake and bioaccurnulation of contaminants from the wastewater. Preferably, the plants may vary in species (e.g., grass species, cotton, sunflower, etc.), variety, age, size, morphology, planting density, etc.

Without wishing to limit the present invention, the PWBR is amendable to adjustment of the levels of the PWBR's various design variables, including all the foregoing mentioned variables to optimize removal of target contaminants from specific types of wastewater. Furthermore, the PWBR is compatible to allow for inclusion or combination with other treatment methods, e.g., ozone, ultraviolet (UV) radiation, activated carbon, filtration, distillation, etc.

### EXAMPLE

The following is a non-limiting example of the present invention. It is to be understood that said example is not intended to limit the present invention in any way. Equivalents or substitutes are within the scope of the present invention.

A physical model of the PWBR was developed. Rubbermaid® 53-Liter Brute® storage containers (70 cm×42.5 cm×27.3 cm) were used as the containers, hereinafter referred to bioreactors. Media barrier screens were positioned in the bioreactor 13 cm from the outlet in order to hold the media in place while leaving space near the outlet for a pump and electrical conductivity probe. The media barrier screens were constructed using 0.64 cm mesh stainless steel hardware cloth fastened to contoured frames made of nonreactive plastic and aluminum.

Inlet holes were drilled at the horizontal center of the front of each bioreactor to create 1.27 cm inlet with a Uniseal®. A 1.27 cm polyvinyl chloride (PVC) tee fitting was connected to the inside of the bioreactor facing up and down and a pipe connected to the bottom so that the ½″ pipe would deliver incoming water at 5 cm off the bottom of the container. A 1.27 cm flexible vinyl hose was connected to the outside of the bioreactor with appropriate fittings which allowed for easy connection to a pump. Outlet holes were centrally drilled using a 7.6 cm hole saw (21.25 cm from each edge and 5 cm off the bottom) for 5.1 cm Uniseals® at the bottom of the outlet end of the bioreactors, 90 degree elbows were attached on the outside of the bioreactors so water volume could be controlled externally by varying the length of the connected standpipe.

The media used in the model PWBR included 12 mm expanded clay pebbles (LECA), 12.7 mm fractured rock, 25.4 mm fractured rock, and 25.4 mm lava rock. Average grain sizes were based on manufacturer specifications. Each medium was rinsed until the rinsate appeared clear and free of visible particulates and then loaded into each bioreactor and filled with municipal water. Two different flow rates were achieved using submersible pumps: Hydrofarm Active Aqua AAPW250, rated at 946 L h⁻¹ (high flow) and Aquaneat SP-180, rated at 606 L h⁻¹ (low flow). Actual pump flow rates were measured by capturing and measuring the overflow from each bioreactor over one minute and were monitored over the course of the experiment to ensure efficiency was not lost. The high flow pump generated an average flow of 9.7 L/min out of the reactor and the low flow pump generated an average flow of 6.9 L/min. Two different water levels were also examined by adjusting the heights of the external standpipe. Water levels for each bioreactor were measured to be within 0.5 mm of one another. At both high and low water levels for each bioreactor, the water was completely drained and captured so accurate measurements could be determined for each media type. Three runs were performed for each set of conditions for RTD tests and two runs were initiated for each mixing test.

A sodium chloride tracer was used for the hydrodynamic experiments. The tracer was prepared by mixing 100 g of laboratory grade sodium chloride in 1 L of deionized water to create a solution with a total dissolved solids (TDS) of 100,000 mg/L. A pump was placed in a separate, adjacent container and connected via the nylon hose attached to each bioreactor inlet. A garden hose was left in the adjacent container with the water running to maintain constant water pressure throughout each run. An electroconductivity (EC) probe was placed in the external standpipe outlet and directed into the flow. The probe was connected to an EC meter (Hanna HI 98143 pH/EC transmitter) which was connected to a CR23x data logger programmed to record every second.

Each tracer volume was measured at 1% of the total bioreactor water volume and injected via syringe into the inlet standpipe. Immediately upon injection, the inlet was capped and power to the pump and EC meter was restored. Trials continued until the EC readings returned to the original reading for at least one minute. After each run, the bioreactor was rinsed and drained multiple times to remove any residual tracer. Tests were repeated for each substrate medium, water level and flow rate for a total of three runs.

A mixing test was performed. The purpose of the mixing test is to assess how long it takes for an injected tracer to become uniformly distributed throughout a bioreactor, which is a good indicator of dispersion. The procedure was to (1) use sodium chloride as the tracer (at the same concentration and volume as in the tracer tests) and (2) measure the amount of time it took for the EC to level off, signaling that the injected tracer had become uniformly distributed throughout the bioreactor. For this procedure, the pump was placed in the open-water section near the outlet and the EC probe was placed in front of the pump inlet. The tracer was injected at the inlet in the same manner as the tracer tests. The resulting concentration versus time curves were graphed, and the average times for 90% mixing were calculated. Complete mixing (100%) acts like a limit that goes to infinity, so the time it takes for a bioreactor to become 90% mixed allowed for better comparisons between treatments.

Three runs for each treatment were completed. EC data for each run were normalized against the background EC to determine mean residence times. Resulting mean residence times with standard deviations are shown in Table 1 with significant differences between treatment conditions identified by differing subscript letters. At the high-water level (high volume) for the tracer tests, the EC readings fluctuated up and down during the test and never went to zero which made the results non-comparable. It appeared that pockets of salinity flowed into the convoluted channels of the lava rock and then were just slow to mix back out, which is why the EC was not observed to go back to zero. Desorption can lead to a slowed tracer breakthrough curve.

The mean residence time eras overall significantly longer at the higher water level and longer at the lower flow rate as might be expected (p<0.05), but there was no significant difference between media types overall. Through a one-way ANOVA, it was determined that there were significant differences between groups (p<0.001), and using Tukey post-hoc analysis (p<0.05), it showed that for the low water level and low flow rate (Table 1—column 2), expanded clay media had a significantly longer mean residence time than the large fractured rock and the lava rock, but all of them were significantly indistinguishable from the small fractured rock. For the low water level with the high flow rate (Table 1—column 3), the expanded clay media had a significantly longer mean residence time than the small fractured rock and the lava rock, but the large fractured rock was not significantly different from the other three media types. For the high water volume and low flow rate (Table 1—column 4), the small fractured rock had a significantly longer mean residence time than the large fractured rock and the expanded clay media, which were not significantly different from one another. However, for the treatment with high water volume and the high flow rate (Table 1—column 5), both the small and large fractured rock had significantly longer mean residence times than the expanded clay media.

It was statistically determined that the treatment levels of ow rate and water level had a greater impact on mean residence time than did the media type itself. Therefore, ANOVA was used again to evaluate those effects. In terms of the flow rates' effect on the mean residence time, the lower flow rate had a significantly longer mean residence time for small fractured rock and expanded clay media (p<0.05) but not for the large rock at the low water volume (p=0.988). In contrast, there was no significant difference between low and high flow rates at the high water volume for large fractured rock and expanded clay media, while the low flow rate in the small fractured rock treatment produced a significantly longer mean residence time than with the high flow rate.

The expected effects of water level were a bit more interesting and less predictable than the flow rate effects as seen in Table 1. A higher water level should theoretically increase the mean residence time if the flow is kept the same, because the average water velocity decreases. However, only the bioreactor with the small fractured rock behaved that way at both levels. Perhaps this could be attributed to the relatively small volume of the test bioreactor. The high volume treatment for large fractured rock also had a significantly longer mean residence time at the high flow rate than it did in the low volume treatment. While the flow rate through the bioreactor is kept constant by the pump itself, the water velocity is affected by the width and depth of the water as well as the porosity of the media. Therefore, it could be a better variable by which to model hydrodynamics through each medium. However, water velocity only had a significant effect on mean residence times for the small fractured rock. Mean water velocity did not have a significant effect on mean residence time for large fractured rock or expanded clay media.

While mean residence time can identify how long an average particle spends in a bioreactor, it does not give a full picture of the dispersion of particles within. For that, one needed to look at the vessel dispersion numbers, N_{d}, which were calculated from residence time distributions and mean residence times. The calculated vessel dispersion numbers can be seen in Table 2 with significant differences between columns noted by subscript letters and significant differences between rows with numbers. In the low water level, low flow treatment, expanded clay had significantly higher dispersion than large rock (p=0.0029), small rock (p=0.0011) and lava rock (p=0.0222). Water level was the most significant predictor of dispersion number overall. However, there were no significant differences in vessel dispersion number across all levels for expanded clay media or large fractured rock. There was a significant difference in vessel dispersion number for small fractured rock, which increased when the volume increased but not just when the flow decreased. Therefore, the vessel dispersion number for small fractured rock appeared to increase as the estimated water velocity decreased. This makes sense because the spaces between the small fractured rock are narrower and more variable than other media tested. Slower moving water will infiltrate through the cracks more easily, while faster moving water could create backchanneling and cause the water to actively seek the path of least resistance. Hydraulic conductivity (or K value), which is the ease with which water moves through the pore spaces, typically goes down over time. When designing a subsurface flow constructed wetland, the design is typically based on 10% of the clean K value, where “clean K” denotes the hydraulic conductivity of water before sediment, bacteria, roots, etc. have begun to fill the void space. In other words, the design has to account for the porosity between the media decreasing by 90% over time. This design consideration would be even more important for an aquaponic media bed which has a constant influx of sediment and fine solids in addition to the bacteria and roots which are present a hydroponic media bed.

Mixing took much less time in the low volume treatments (Table 3). In the high-volume treatments, almost all the trials took over 6000 s (100 min). The tests were stopped once the EC appeared to level off (the EC did not change for one minute). The ANOVA analysis showed that there was a significant difference in 90% mixing times between media types (p=0.0092). In addition, the ANOVA showed that flow had a significant effect on 90% mixing time among media types (p=0.0036), but not overall.

For the low flow regime, the expanded clay and small fractured rock mixed significantly faster than the large fractured rock, which had a significantly faster mixing time than the lava rock. This gave further reason to believe that the tracer was getting trapped in the convoluted matrix of the lava rock medium. Under high flow conditions, the expanded clay and lava rock mixed significantly faster than the small and large fractured rock, which were not significantly different from each other.

The mixing tests showed that the tracer was able to disperse through the expanded clay media much quicker than it could through either size of fractured rock. While the lava rock appeared to be good at mixing under high flow conditions, it did not mix well under low flow. This could be due to the porous nature of the lava rock which allowed for matrix diffusion of the tracer, causing a significant delay in mixing. Furthermore, since the inlet water is entering close to the bottom (within 5 cm of the bottom) and flowing horizontally, it makes sense that vertical dispersion would take a bit longer when the height of the water is increased, especially since the tracer has a higher density than the water flowing through the bioreactors. Mixing times were ultimately abandoned at the high water level treatments because tests often resulted in errors or did not reach a completely mixed state after several hours.

TABLE 1
Mean hydraulic residence times in seconds.

| | Low Water Level | | High Water Level | |
|---|---|---|---|---|
| Media type | Low Flow | High Flow | Low Flow | High Flow |
| Expanded Clay | 148.7 ± 8.0ₐ | 115.7 ± 8.3ₐ | 135.7 ± 9.9_{b} | 118.9 ± 13.8_{b} |
| Small Fractured Rock | 128.1 ± 17.3_{ab} | 89.7 ± 0.6_{b} | 203.1 ± 13.4ₐ | 138.7 ± 2.3ₐ |
| Large Fractured Rock | 114.6 ± 14.1_{b} | 108.0 + 21.5_{ab} | 137.8 ± 12.4_{b} | 152.3 ± 16.3ₐ |
| Lava Rock | 121 ± 1.4_{b} | 95 ± 7.1_{b} | X | X |

TABLE 2
Vessel dispersion numbers.

| | Low Water Level | | High Water Level | |
|---|---|---|---|---|
| Media type | Low Flow | High Flow | Low Flow | High Flow |
| Expanded Clay | 14.0 ± 2.5 _{a, 1} | 15.3 ± 10.6 _{c, 1} | 10.0 ± 3.5 _{d, 1} | 12.4 ± 5.8 _{e, 1} |
| Small Fractured Rock | 2.6 ± 0.6 _{b, 2} | 4.2 ± 0.3 _{c, 2} | 14.2 ± 4.8 _{d, 3} | 9.4 ± 3.4 _{e, 23} |
| Large Fractured Rock | 4.3 ± 0.4 _{b, 5} | 8.9 ± 2.3 _{c, 5} | 4.4 ± 1.3 _{d, 5} | 8.0 ± 4.4 _{e, 5} |
| Lava Rock | 6.6 ± 2.2 _{b} | 5.2 ± 0.8 _{c} | X | X |

TABLE 3
90% mixing times in seconds.

| | Low Water Level | | High Water Level | |
|---|---|---|---|---|
| | Low | High | Low | High |
| Media type | Flow | Flow | Flow | Flow |
| Expanded Clay | 267 + 157 ₐ₁ | 318 + 2 ₐ₁ | X | X |
| Small Fractured Rock | 336 ± 17 ₐ₁ | 782 ± 147 _{b2} | X | X |
| Large Fractured Rock | 854 ± 227 _{b1} | 809 + 175 _{b1} | X | X |
| Lava Rock | 1835 ± 617 _{c2} | 390 ± 21 ₐ₁ | X | X |

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

1. A phyto-mediated wastewater treatment bioreactor (PWBR) (100) comprising a flow path (135), a growing medium (140) disposed in the flow path (135), and a plurality of plant units (150) planted in the growing medium (140),
wherein wastewater containing a first concentration of dissolved contaminants is introduced into the flow path (135) via an influent port (120), wherein as the wastewater flows through the flow path (135), the plant units (150) and/or microorganisms adhering to surfaces of the plant roots and growing medium assimilate, bioaccumulate and/or break the contaminants such that the wastewater exits through an effluent port (125) with a reduced concentration of contaminants.

2. A phyto-mediated wastewater treatment bioreactor (PWBR) (100) comprising:
a) a container (110) having an upstream end (112) and a downstream end (114);
b) an influent port (120) fluidly coupled to the container (110) at the upstream end (112);
c) an effluent port (125) fluidly coupled to the container (110) at the downstream end (114);
d) a plurality of flow guides (130) disposed in the container (110), the flow guides (130) dividing the container (110) into a plurality of fluidly connected container sections (135);
e) a growing medium (140) disposed in the container sections (135); and
f) a plurality of plant units (150) planted in the growing medium (140);
wherein wastewater containing a first concentration of dissolved contaminants is introduced into the container (110) via the influent port (120) and is flowed through the container sections (135), wherein the plant units (150) and/or microorganisms adhering to surfaces of the plant roots and growing medium assimilate, bioaccumulate and/or break down the contaminants such that the wastewater exits through the effluent port (125) with a reduced concentration of contaminants.

3. (canceled)

4. The PWBR (100) of claim 2, wherein the flow guides (130) are parallel to each other.

5. The PWBR (100) of claim 2, wherein the flow guides (130) are baffles or straight panels.

6. (canceled)

7. The PWBR (100) of claim 2, wherein the flow guides (130) are zigzag, trapezoidal, straight, or wavy corrugated panels or ribbed panels.

8. The PWBR (100) of claim 2, wherein the flow guides (130) are oriented radially relative to an axis (A) extending from the upstream end (112) to the downstream end (114).

9. The PWBR (100) of claim 2, wherein the flow guides (130) are oriented axially relative to an axis (A) extending from the upstream end (112) to the downstream end (114).

10. (canceled)

11. (canceled)

12. The PWBR (100) of claim 2, wherein the flow guides (130) comprise a polymer or metal material.

13. The PWBR (100) of claim 2, wherein the flow guides (130) are solid or perforated.

14. The PWBR (100) of claim 2, wherein the flow guides (130) comprise wire netting.

15. The PWBR (100) of claim 2, wherein the growing medium (140) comprises fractured rocks, lava rocks, soil, sand, expanded clay, peat moss, perlite, vermiculite, or a combination thereof.

16. The PWBR (100) of claim 2, wherein the container (100) is cubic, rectangular cubic, cylindrical, or asymmetric is shape.

17. The PWBR (100) of claim 1, wherein the wastewater makes a single-pass through the PWBR.

18. The PWBR (100) of claim 2, wherein the wastewater is re-circulated through the PWBR.

19. The PWBR (100) of claim 2 further comprising a pump for moving the wastewater through the PWBR.

20. The PWBR (100) of claim 2, wherein one or more of volumetric flow rate, flow velocity, depth, and temperature is controlled and/or varied to maintain plant stability and achieve maximum reduction in contaminant concentration.

21. (canceled)

22. A method of removing contaminants of emerging concern (CECs) from wastewater, said method comprising:
a) providing a PWBR according to claim 2;
b) introducing the wastewater into the container (110) via the influent port (120); and
c) flowing the wastewater through the PWBR;
wherein the plant units (150) and/or microorganisms adhering to surfaces of the plant roots and growing medium assimilate, bioaccumulate and/or break down the contaminants such that the wastewater exits through the effluent port (125) with a reduced concentration of CECs, thereby producing treated wastewater.

23. The method of claim 22, further comprising recirculating the wastewater through the PWBR.

24. The method of claim 22, further comprising collecting and recycling the treated wastewater.

25. The method of claim 22, further comprising treating the wastewater with ozonation, ultraviolet (UV) radiation, activated carbon, filtration, or a combination thereof prior to or after treatment by the PWBR.
